(19) United States
(12) Patent Application Publication
(10) Pub. No.: US 2025/0197184 A1
(43) Pub. Date: Jun. 19, 2025

(54) Collapsible Container Set

(71) Applicant: Progressive International Corp., Kent, WA (US)

(72) Inventors: Delphine Lepeintre, Bellevue, WA (US); Lawrence Hauser, Auburn, WA (US)

(73) Assignee: Progressive International Corp., Kent, WA (US)

(21) Appl. No.: 18/544,752

(22) Filed: Dec. 19, 2023

(51) Int. Cl. B67C 11/02; B65B 39/02

(52) U.S. Cl. CPC B67C 11/02; B65B 39/02

(57) ABSTRACT

A collapsible container set includes a plurality of containers, each being configurable between an expanded position and a collapsed position. Each container includes a base and a rim, with a flexible sidewall extending from the base to the rim, the sidewall having a plurality of living hinges allowing the containers to collapse. The containers are nestable within one another in the collapsed position, providing for a compact storage configuration.

### BACKGROUND OF THE INVENTION

It is useful to have a set of containers for cooking and baking, particularly for instances when a container of a particular size is needed. For example, a funnel is a useful container in this context, in order to aid in pouring liquids or other ingredients into a jar or a bottle. The sizes of the bottles can vary greatly, however, and as a consequence some funnels are too large and others are too small for the job. A funnel set can solve this problem, providing several funnels of different sizes so that the best one can be selected and used. Each funnel takes up quite a lot of space, making it awkward to store a set of several funnels. Generally, the same can be true of other containers, such as measuring cups.

### SUMMARY OF THE INVENTION

A collapsible container set includes a first container having a first container base and a first container rim, with a first container sidewall extending from the first container base to the first container rim to define a first container interior space, the first container sidewall having a plurality of first container living hinges configured to allow the first container to be positioned in either an expanded position or a collapsed position, the first container having a first container collapsed height when in the collapsed position.

A second container includes a second container base and a second container rim, with a second container sidewall extending from the second container base to the second container rim to define a second container interior space, the second container sidewall having a plurality of second container living hinges configured to allow the second container to be positioned in either an expanded position or a collapsed position, the second container having a second container collapsed height when in the collapsed position, the second container when in the collapsed position having at least one second container upper folded living hinge and at least one second container lower folded living hinge from among the plurality of second container living hinges.

The preferred second container further, in the collapsed position, has a second container upper volume defined by a second container upper volume height between the second container rim and the at least one second container upper folded living hinge, the second container upper volume height being at least at least seventy percent as great as the first container collapsed height.

The first container is nestable within the second container, and within the second container upper volume, when the first container is in the collapsed position and the second container is in the collapsed position.

In some examples, a third container has a third container base and a third container rim, with a third container sidewall extending from the third container base to the third container rim to define a third container interior space, the third container sidewall having a plurality of third container living hinges configured to allow the third container to be positioned in either an expanded position or a collapsed position, the third container having a third container collapsed height when in the collapsed position, the third container when in the collapsed position having at least one third container upper folded living hinge and at least one third container lower folded living hinge from among the plurality of third container living hinges.

The third container further, in the collapsed position, preferably has a third container upper volume defined by a third container upper volume height between the third container rim and the at least one third container upper folded living hinge, the third container upper volume height being at least at least seventy percent as great as the second container collapsed height.

Preferably, the second container is nestable within the third container, and within the third container upper volume, when the second container is in the collapsed position and the third container is in the collapsed position.

In preferred versions, the first container is a funnel, wherein the first container base is configured as a first container exit tube, the second container is a funnel, wherein the second container base is configured as a second container exit tube, and the third container is a funnel, wherein the third container base is configured as a third container exit tube.

In accordance with preferred versions, when the first container is nested within the second container, the first container exit tube is received within the second container exit tube; and further wherein when the second container is nested within the third container, the second container exit tube is received within the third container exit tube.

Preferably, the second container height is between seventy percent and one hundred percent as great as the first container collapsed height. More preferably, the third container height is between seventy percent and one hundred percent as great as the second container collapsed height.

In most preferred versions, when the first container is in the collapsed position and nested within the second container, while the second container is also in the collapsed position and nested within the third container when the third container is in the collapsed position, the plurality of second container living hinges are positioned vertically below the third container rim.

In preferred versions, when the first container is in the collapsed position and nested within the second container, while the second container is in the collapsed position and nested within the third container when the third container is in the collapsed position, the plurality of first container living hinges are positioned vertically below the third container rim.

Preferably, the plurality of first container living hinges comprises four living hinges.

Preferably, the first container further has a first container handle and the second container has a second container cavity formed in the rim, the first container handle being received within the second container cavity.

Another preferred collapsible container set includes a first container having a first container base and a first container rim, with a first container sidewall extending from the first container base to the first container rim to define a first container interior space, the first container sidewall having a plurality of first container living hinges configured to allow the first container to be positioned in either an expanded position or a collapsed position, the first container having a first container collapsed height when in the collapsed position.

A second container has a second container base and a second container rim, with a second container sidewall extending from the second container base to the second container rim to define a second container interior space, the second container sidewall having a plurality of second container living hinges configured to allow the second container to be positioned in either an expanded position or a collapsed position, the second container having a second container collapsed height when in the collapsed position, the second container when in the collapsed position having at least one second container upper folded living hinge and at least one second container lower folded living hinge from among the plurality of second container living hinges.

A third container has a third container base and a third container rim, with a third container sidewall extending from the third container base to the third container rim to define a third container interior space, the third container sidewall having a plurality of third container living hinges configured to allow the third container to be positioned in either an expanded position or a collapsed position, the third container having a third container collapsed height when in the collapsed position, the third container when in the collapsed position having at least one third container upper folded living hinge and at least one third container lower folded living hinge from among the plurality of third container living hinges.

Preferably, when the first container is in the collapsed position, the second container is in the collapsed position, and the third container is in the collapsed position, the first container is nestable within the second container and the second container is nestable within the third container, such that the plurality of second container living hinges are positioned vertically below the third container rim.

Preferably, when the first container is in the collapsed position and nested within the second container, while the second container is in the collapsed position and nested within the third container when the third container is in the collapsed position, the plurality of first container living hinges are positioned vertically below the third container rim.

### BRIEF DESCRIPTION OF THE DRAWINGS

The preferred embodiments of the invention are described below with reference to the following drawings.

FIG. 1 is a front isometric view of a preferred collapsible container set, shown with each of three containers in a collapsed position.

FIG. 2 is a front isometric view of the preferred collapsible container set of FIG. 1, shown with each of the three containers in an expanded position.

FIG. 3 is a front isometric view of a first container from among a preferred collapsible container set.

FIG. 4 is a front elevational view of a first container from among a preferred collapsible container set.

FIG. 5 is a front elevational view of a first container from among a preferred collapsible container set, shown in the collapsed position.

FIG. 6 is a front elevational view of a first container from among a preferred collapsible container set, shown in a collapsed position and viewed along section plane 15-15 indicated in FIG. 1.

FIG. 7 is a front isometric view of a second container from among a preferred collapsible container set.

FIG. 8 is a front elevational view of a second container from among a preferred collapsible container set.

FIG. 9 is a front elevational view of a second container from among a preferred collapsible container set, shown in the collapsed position.

FIG. 10A is a front elevational view of a second container from among a preferred collapsible container set, shown in a collapsed position and viewed along section plane 15-15 indicated in FIG. 1.

FIG. 10B is an additional view of the second container, in accordance with FIG. 10B.

FIG. 11 is a front isometric view of a third container from among a preferred collapsible container set.

FIG. 12 is a front elevational view of a third container from among a preferred collapsible container set.

FIG. 13 is a front elevational view of a third container from among a preferred collapsible container set, shown in the collapsed position.

FIG. 14A is a front elevational view of a third container from among a preferred collapsible container set, shown in a collapsed position and viewed along section plane 15-15 indicated in FIG. 1.

FIG. 14B is an additional view of the third container, in accordance with the view of FIG. 14A.

FIG. 15 is a front elevational sectional view of the preferred collapsible container set, shown with each of the three containers in a collapsed position and viewed along section plane 15-15 of FIG. 1.

FIG. 16 is a front elevational sectional view of the preferred collapsible container set, in accordance with the view of FIG. 15.

### DETAILED DESCRIPTION OF THE PREFERRED EMBODIMENT

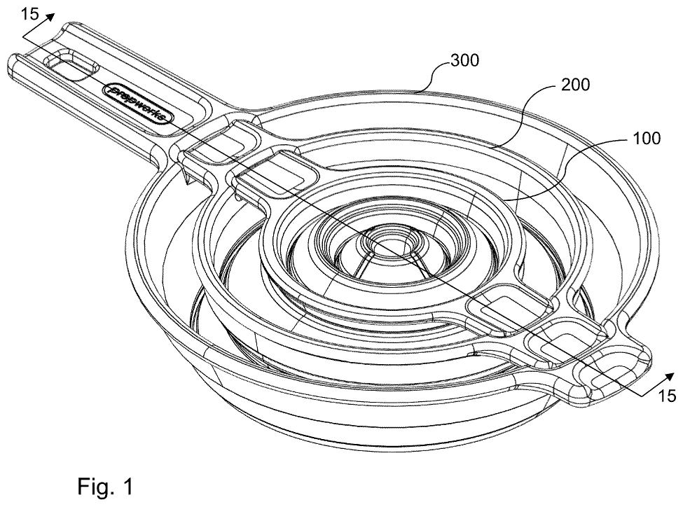

A preferred set of collapsible containers is shown in FIG. 1, in this case illustrating a first container 100, a second container 200, and a third container 300. As shown, the first container is the smallest container, the second container is of intermediate size, and the third container is the largest container. In the illustrated form, each of the containers is configured as a funnel, thus having an upper open rim and sidewalls leading to an exit tube, as described further below. In other versions, the containers may be configured as strainers having multiple drain holes, or as containers having no drain holes, such as measuring cups or bowls.

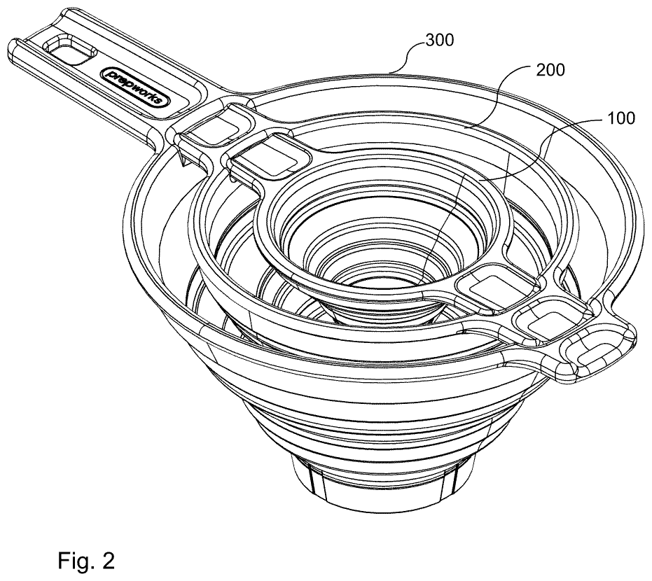

FIG. 1 shows the collapsible container set as having three collapsible containers, each being in a collapsed position and nested together. FIG. 2 shows the same set of three collapsible containers, in this case each still being nested but in an expanded position. In other versions, the set may have only two containers, or may have four or more containers.

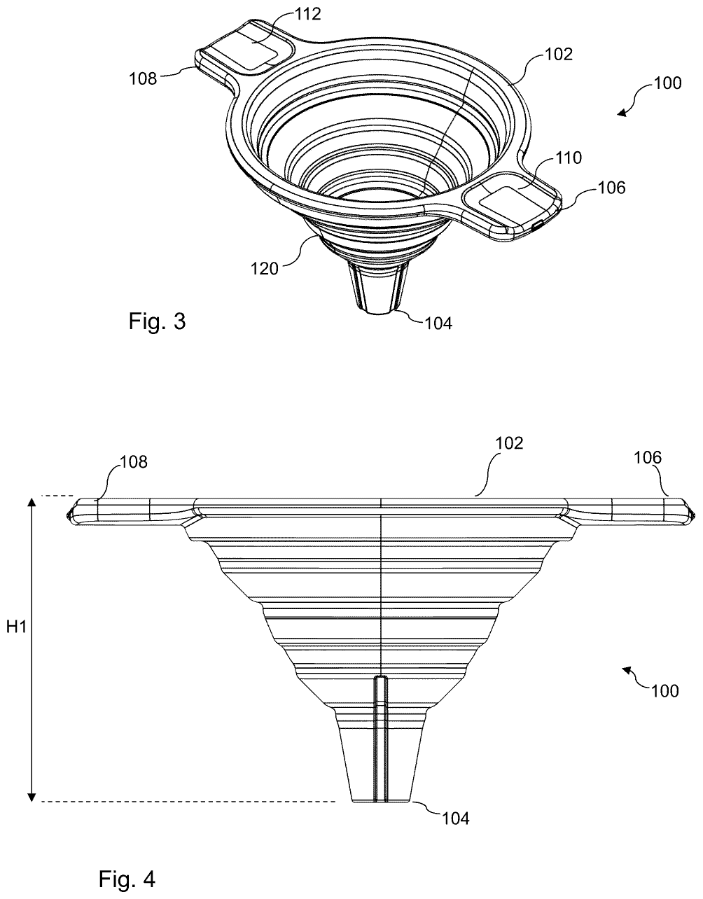

The smallest container 100 within the illustrated preferred set of containers from FIGS. 1 and 2 is shown in FIGS. 3-6. In FIG. 3, the smallest container 100 is shown in an isometric view, in an expanded position. The illustrated example of the smallest container includes an upper rim 102 and a base which is configured as a lower exit tube 104, with a sidewall 120 extending upwardly from the tube to the rim. Most preferably, the sidewall is inclined so that it extends outwardly as it progresses upwardly from the tube to the rim. Optionally, the rim may include one or more handles, including a pair of diametrically positioned handles 106, 108 such as shown in the illustrated example. The handles may include shallow depressions 110, 112 on the upper side of each handle.

FIG. 4 shows an elevational view of the smallest container 100, further indicating an expanded height H1 of the smallest tube from the bottom of the exit tube 104 to the top of the rim 102.

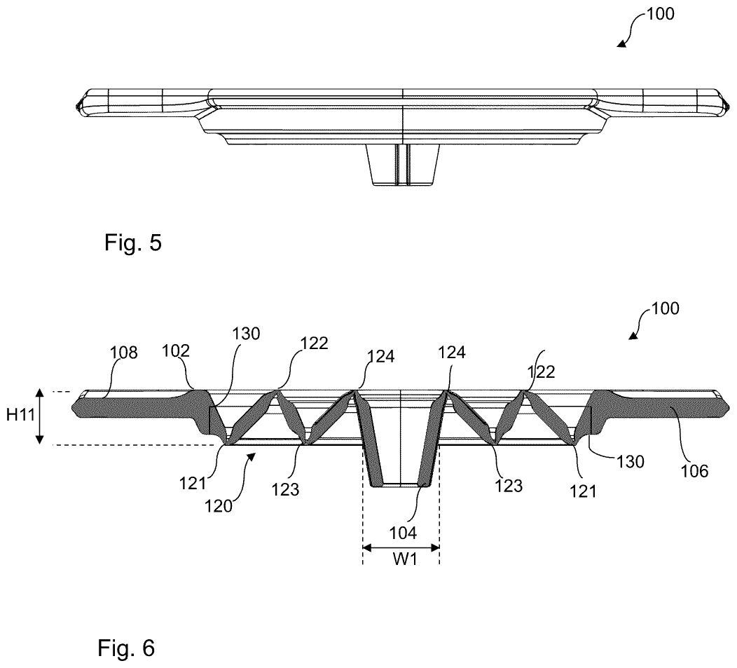

FIG. 5 shows an elevational view of the smallest container 100, as in FIG. 4, but in this case the container is in a collapsed position, having been folded at living hinge locations formed in the sidewall as best seen in the sectional view of FIG. 6.

FIG. 6 is a sectional view of the smallest container, taken along section plane 15-15 from FIG. 1, but isolating the smallest container 100 from the other two containers 200, 300. The smallest container is in the collapsed position in FIG. 6, shown with the sidewall 120 folded at four living hinge locations 121, 122, 123, and 124. Generally inclined sidewall segments are thereby produced between the living hinge locations, including an uppermost segment 130 that is preferably formed by at least a portion of the rim 102, which may be formed from a plastic material which is more rigid than a preferred elastomeric material (such as silicone) which may be used for the sidewall. In the illustrated example, the uppermost segment is formed partially by the rim and partially by a portion of the elastomeric sidewall. Three additional sidewall segments are formed by the living hinges, including a first intermediate section between hinges 121 and 122, a second intermediate section between hinges 122 and 123, and a third intermediate section between hinges 123 and 124. In the illustrated example, the tube 104 extends downwardly from the lowest hinge 124, although in other examples the container may have a container floor section extending between the lowest hinge, or yet a different hole arrangement.

In the collapsed position, the smallest container 100 defines a smallest container collapsed height H11 which extends between the top of the rim 102 and the lowest living hinge location (in this case, hinges 121 or 123 or both) of the container in the collapsed position. As shown a portion of the tube 104 extends downwardly below (that is, in a direction away from the top of the rim) the lowest living hinge locations 121, 123, and has a diameter W1 taken at the location of the living hinges 121, 123 in the collapsed position. In other examples, the tube may not extend below the lowest living hinges 121, 123, or may be configured as a floor of the container extending between the lowest living hinges, rather than as an exit tube.

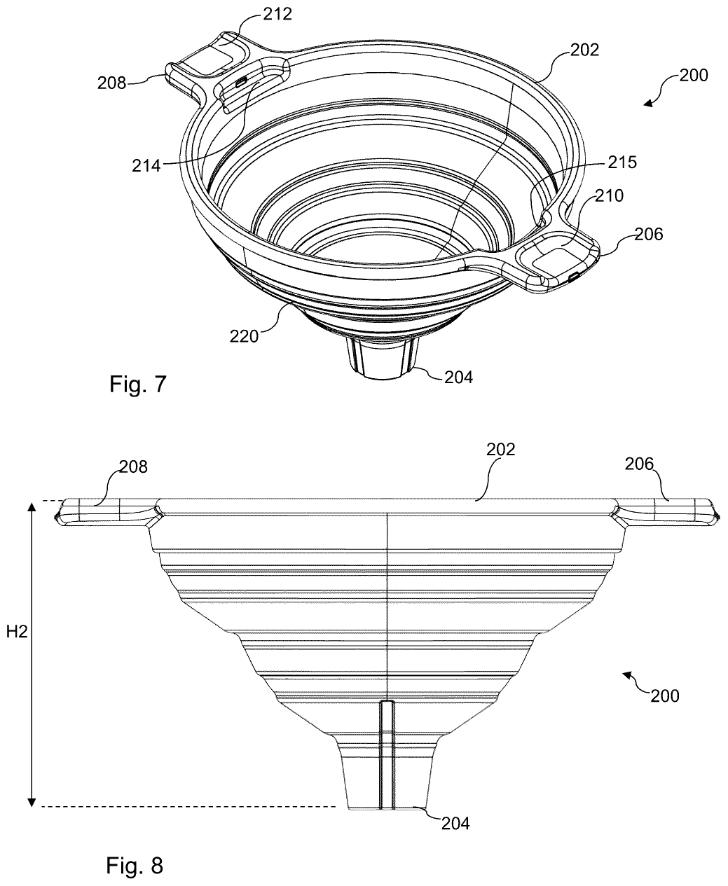

The intermediate container 200 is illustrated in FIGS. 7-10B, each presented in the same manner as with FIGS. 3-6 for the smallest container. Thus, the intermediate container includes a base configured as a lower tube 204 and a flexible/elastomeric sidewall 220 extending outwardly and upwardly to an upper rim 202. One or more handles 206, 208 are optionally provided, such as the pair of handles 206, 208 positioned diametrically opposite on another on the rim. Each handle may include a central depression 210, 212. The rim 202 may further include a complementary cavity to receive the handle from the smallest container. In the illustrated example, a pair of cavities 214, 215 are provided, diametrically opposite one another on the rim, and being sized and positioned to receive the handles of the smallest container. Most preferably, the handles of the smallest container are snugly received within the pair of cavities, such as by using a snap-fit or friction-fit, to retain the smallest container within the intermediate container for storage as described further below. A tab-and-slot or other detail may also be included on the handle and cavity to further secure the handles within the cavities.

FIG. 8 shows the intermediate container in an elevational view, in the expanded position. In this position, the container defines a heigh H2 from the bottom of the exit tube 204 to the top of the rim 202.

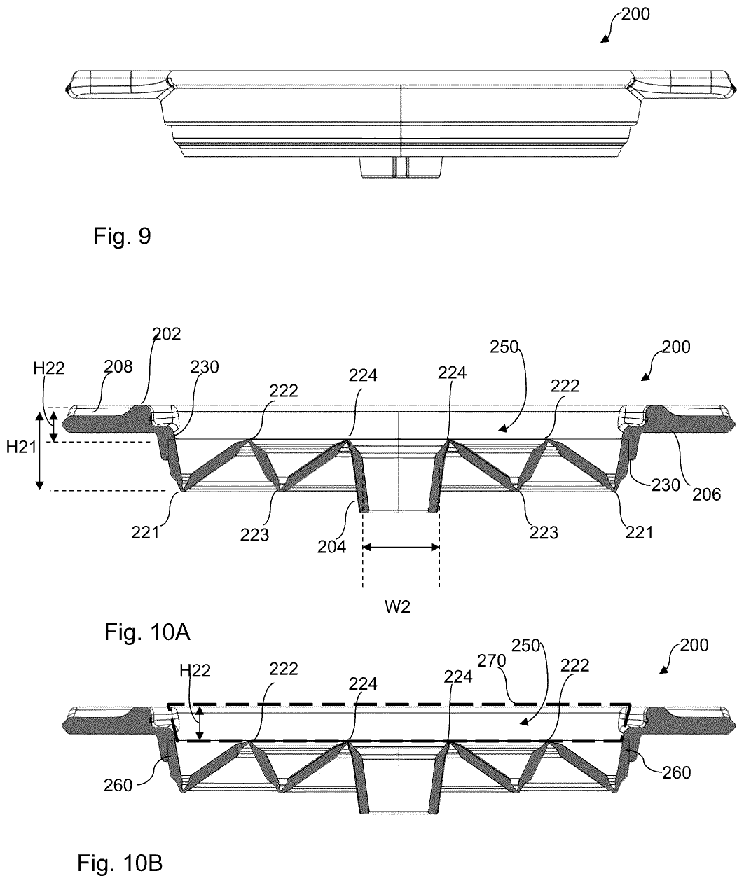

FIG. 9 shows an elevational view of the intermediate container 200, as in FIG. 8, but in this case the container is in a collapsed position, having been folded at living hinge locations formed in the sidewall as best seen in the sectional view of FIGS. 10A and 10B.

FIGS. 10A and 10B are sectional views of the intermediate container, taken along section plane 15-15 from FIG. 1, but isolating the intermediate container 200 from the other two containers 100, 300. The intermediate container is in the collapsed position in FIGS. 10A and 10B, shown with the sidewall 220 folded at living hinge locations 221, 222, 223, and 224. Generally inclined sidewall segments are thereby produced between the living hinge locations, including an uppermost segment 230 that is preferably formed by at least a portion of the rim 202, which may be formed from a plastic material which is more rigid than a preferred elastomeric material (such as silicone) which may be used for the sidewall. In the illustrated example, the uppermost segment is formed partially by the rim and partially by a portion of the elastomeric sidewall, which meet at an interface 260 best indicated in FIG. 10B. Three additional sidewall segments are formed by the living hinges, including a first intermediate section between hinges 221 and 222, a second intermediate section between hinges 222 and 223, and a third intermediate section between hinges 223 and 224. In the illustrated example, the tube 204 extends downwardly from the lowest hinge 224, although in other examples the container may have a container floor section extending between the lowest hinge, or yet a different hole arrangement.

In the collapsed position, the intermediate container 200 defines an intermediate container collapsed height H21 which extends between the top of the rim 202 and the lowest living hinge locations 221, 223 of the container in the collapsed position. As shown a portion of the tube 204 extends downwardly below (that is, in a direction away from the top of the rim) the lowest living hinge locations 221, 223, and has an intermediate tube diameter W2 taken along a vertical line which intersects a horizontal plane extending through the location of the living hinges 221, 223 in the collapsed position.

The intermediate container in the collapsed position further includes an upper volume 250 defined by the space above the upper living hinge locations 222, 224 and the top of the rim 202. As indicated in FIG. 10B, this upper volume space 250 is preferably generally shaped as an upper conical segment 270 (which appears as a trapezoid in the sectional view of FIG. 10B), having a height H22 from the upper living hinge locations to the top of the rim. In the preferred versions of the invention, the sidewall segments and living hinges are arranged so that the folded sidewall (formed by the sidewall segments in the collapsed position) occupies only a fraction of the collapsed height H21, thereby leaving ample room in the upper interior volume to receive the smallest container 100 when it is in the collapsed position; in other words, the upper volume space height H22 is a fraction of the collapsed height H21. Most preferably, at least 70 percent of the volume of the smallest container fits within this interior volume 250 when the smallest container is collapsed, meaning that the upper volume space height H22 of the intermediate container is at least 70 percent of the collapsed height H11 of the smallest container. Even more preferably, the upper volume space height H22 of the intermediate container is at least 80 percent or at least 90 percent of the collapsed height H11 of the smallest container, and in a further preferred version the upper volume space height H22 is actually as large or larger than the collapsed height H11 of the smallest container, so that the smallest container, when collapsed, can fit fully within the interior volume 250.

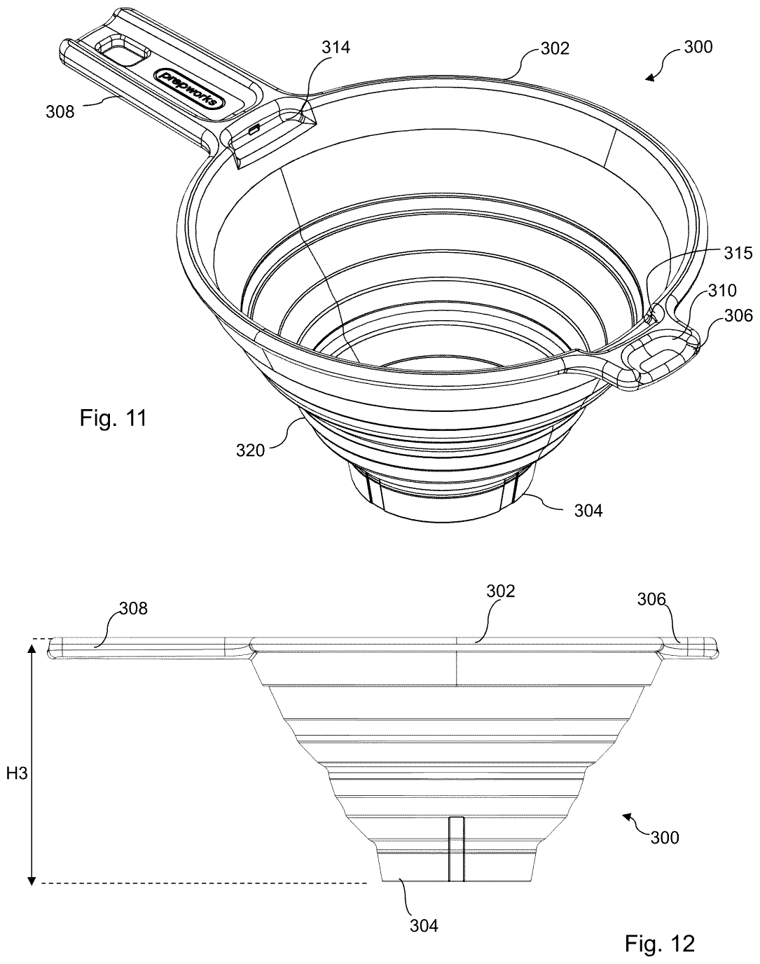

The largest container 300 is illustrated in FIGS. 11-13B, each presented in the same manner as with FIGS. 3-6 for the smallest container. Thus, the largest container includes a base configured as a lower tube 304 and a flexible/elastomeric sidewall 320 extending outwardly and upwardly to an upper rim 302. One or more handles 306, 308 are provided, such as the pair of handles 306, 308 positioned diametrically opposite on another on the rim. Each handle may include a central depression 310, 312. The rim 302 may further include a complementary cavity to receive the handle from the intermediate container. In the illustrated example, a pair of cavities 314, 315 are provided, diametrically opposite one another on the rim, and being sized and positioned to receive the handles of the intermediate container. Most preferably, the handles of the intermediate container are snugly received within the pair of cavities, including by using a snap-fit or friction-fit, to retain the intermediate container within the largest container for storage as described further below.

FIG. 12 shows the largest container in an elevational view, in the expanded position. In this position, the container defines a largest container height H3 from the bottom of the exit tube 304 to the top of the rim 302.

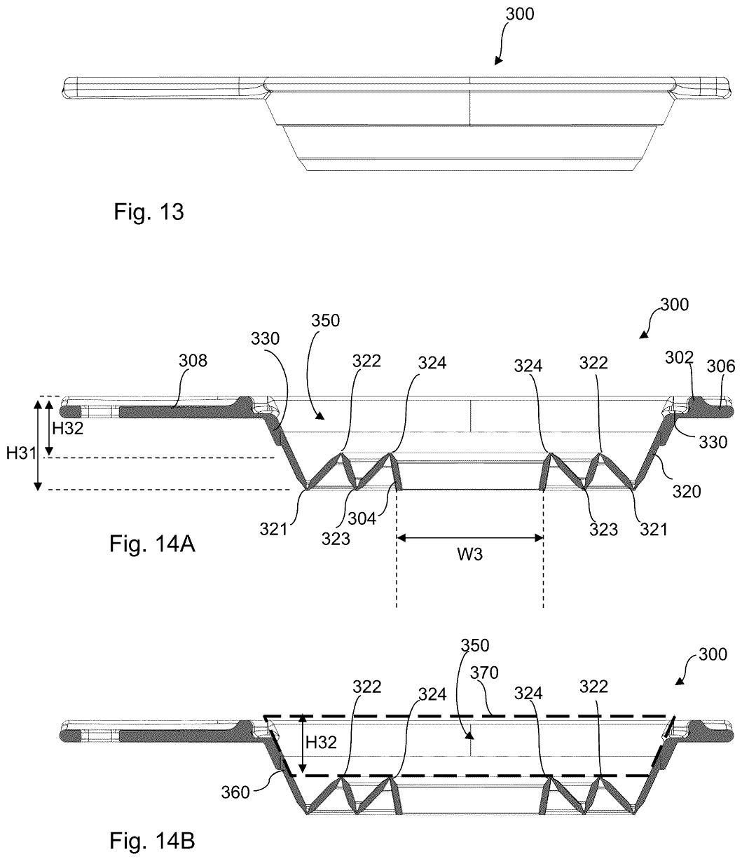

FIG. 13 shows an elevational view of the largest container 300, as in FIG. 12, but in this case the container is in a collapsed position, having been folded at living hinge locations formed in the sidewall as best seen in the sectional view of FIGS. 14A and 14B.

FIGS. 14A and 14B are sectional views of the largest container, taken along section plane 15-15 from FIG. 1, but isolating the largest container 300 from the other two containers 100, 200. The largest container is in the collapsed position in FIGS. 14A and 14B, shown with the sidewall 320 folded at living hinge locations 321, 322, 323, and 324. Generally inclined sidewall segments are thereby produced between the living hinge locations, including an uppermost segment 330 that is preferably formed by at least a portion of the rim 302, which may be formed from a plastic material which is more rigid than a preferred elastomeric material (such as silicone) which may be used for the sidewall. In the illustrated example, the uppermost segment is formed partially by the rim and partially by a portion of the elastomeric sidewall, which meet at an interface 360 best indicated in FIG. 14B. Three additional sidewall segments are formed by the living hinges, including a first intermediate section between hinges 321 and 322, a second intermediate section between hinges 322 and 323, and a third intermediate section between hinges 323 and 324. In the illustrated example, the tube 304 extends downwardly from the lowest hinge 324, although in other examples the container may have a container floor section extending between the lowest hinge, or yet a different hole arrangement.

In the collapsed position, the largest container 300 defines a largest container collapsed height H31 which extends between the top of the rim 302 and the lowest living hinge locations 321, 323 of the container in the collapsed position. As shown, a portion of the tube 304 extends downwardly below (that is, in a direction away from the top of the rim) the lowest living hinge locations 321, 323, and has an intermediate tube diameter W3 taken along a vertical line which intersects a horizontal plane extending through the location of the living hinges 321, 323 in the collapsed position.

The largest container in the collapsed position further includes an upper volume 350 defined by the space above the upper living hinge locations 322, 324 and the top of the rim 302. As indicated in FIG. 14B, this upper volume space 350 is preferably generally shaped as an upper conical segment 370 (which appears as a trapezoid in the sectional view of FIG. 14B), having a height H32 from the upper living hinge locations to the top of the rim. In the preferred versions of the invention, the sidewall segments and living hinges are arranged so that the folded sidewall (formed by the sidewall segments in the collapsed position) occupies only a fraction of the collapsed height H31, thereby leaving ample room in the upper interior volume to receive the intermediate container 200 when it is in the collapsed position; in other words, the upper volume space height H32 is a fraction of the collapsed height H31. Most preferably, at least 70 percent of the volume of the intermediate container fits within this interior volume 350 when the intermediate container is collapsed, meaning that the upper volume space height H32 of the largest container is at least 70 percent of the collapsed height H21 of the intermediate container. Even more preferably, the upper volume space height H32 of the largest container is at least 80 percent or at least 90 percent of the collapsed height H21 of the intermediate container, and in a further preferred version the upper volume space height H32 is actually as large or larger than the collapsed height H21 of the intermediate container, so that the intermediate container, when collapsed, can fit fully within the interior volume 350.

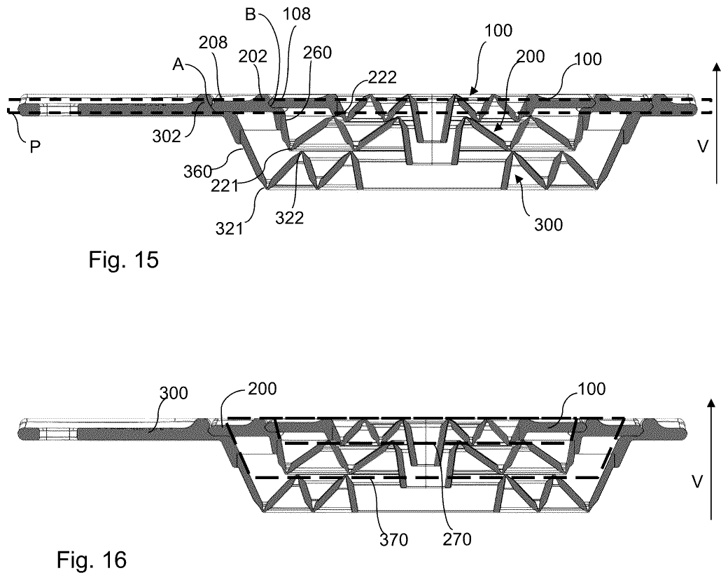

Preferred versions of a collapsible container set are shown in FIGS. 15 and 16, which are sectional views taken along section line 15-15 in FIG. 1. The illustrations in FIGS. 15 and 16 are the same in all respects, except that FIG. 16 illustrates the upper conical spaces 270 and 370 for the largest and intermediate containers. As shown in FIGS. 15 and 16, the collapsed smallest container 100 fits substantially within the upper volume space height 270 of the intermediate container 200, and in particular, there is sufficient room within the upper volume space height 270 so that the smallest container, when collapsed and seated within this space, does not extend substantially vertically above the upper rim of the intermediate container 200 (in which the vertical direction V is indicated in FIG. 16). Likewise, the collapsed intermediate container 200 fits substantially within the upper volume space height 370 of the largest container 300, so that there is sufficient room within the upper volume space height 370 so that the intermediate container, when collapsed and seated within this space, does not extend substantially vertically above the upper rim of the largest container 300.

As further seen in FIG. 16, when each of the separate containers 100, 200, 300 is in the collapsed position and nested within one another, a handle (that is, a peripheral, radially-outward extension of the rim 102, 202, 302) from an inner container is in contact with the rim of the next-adjacent larger/outer container. Thus, in the illustrated example, the handle 108 from the smallest container 100 is in contact with the rim 202 of the intermediate container 200, while the handle 208 of the intermediate container is in contact with the rim 302 of the largest container 300. Most preferably, as noted above, the contact regions of the rims are formed with a cavity to snugly receive the handles and firmly secure them.

In accordance with a further preferred aspect, the nature of the rim and the orientation of the living hinges in each container allows for a compact storage arrangement. Accordingly, when the plurality of containers are nested and in the collapsed positions such as shown in FIG. 15, at least a portion of the location of contact between the rim of one container and the handle of an adjacent inner container lies in a common horizontal plane extending through the location of contact between the rim of an adjacent outer container and the rim of the container. Thus, as seen in FIG. 15, there is a contact interface A between the rim 302 of the outer container 300 and the handle 208 of the intermediate container. There is also a contact interface B between the rim 202 of the intermediate container and the handle 108 of the smallest container. At least a portion of the contact interfaces A and B lie within a common plane P extending horizontally through the rim of each container (wherein the horizontal direction is defined by the plane P, and is perpendicular to the vertical axis V). The common “plane” P is illustrated as having a thickness to it, rather than being defined as an infinitely small point, and is more particularly defined as the vertical thickness of the largest of the any of the container handles, taken at the interface location (e.g., A or B).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

I claim:

1. A collapsible container set, comprising:
a first container having a first container base and a first container rim, with a first container sidewall extending from the first container base to the first container rim to define a first container interior space, the first container sidewall having a plurality of first container living hinges configured to allow the first container to be positioned in either an expanded position or a collapsed position, the first container having a first container collapsed height when in the collapsed position;
a second container having a second container base and a second container rim, with a second container sidewall extending from the second container base to the second container rim to define a second container interior space, the second container sidewall having a plurality of second container living hinges configured to allow the second container to be positioned in either an expanded position or a collapsed position, the second container having a second container collapsed height when in the collapsed position, the second container when in the collapsed position having at least one second container upper folded living hinge and at least one second container lower folded living hinge from among the plurality of second container living hinges;
the second container further, in the collapsed position, having a second container upper volume defined by a second container upper volume height between the second container rim and the at least one second container upper folded living hinge, the second container upper volume height being at least at least seventy percent as great as the first container collapsed height;
wherein the first container is nestable within the second container, and within the second container upper volume, when the first container is in the collapsed position and the second container is in the collapsed position.

2. The collapsible container set of claim 1, further comprising:
a third container having a third container base and a third container rim, with a third container sidewall extending from the third container base to the third container rim to define a third container interior space, the third container sidewall having a plurality of third container living hinges configured to allow the third container to be positioned in either an expanded position or a collapsed position, the third container having a third container collapsed height when in the collapsed position, the third container when in the collapsed position having at least one third container upper folded living hinge and at least one third container lower folded living hinge from among the plurality of third container living hinges;
the third container further, in the collapsed position, having a third container upper volume defined by a third container upper volume height between the third container rim and the at least one third container upper folded living hinge, the third container upper volume height being at least at least seventy percent as great as the second container collapsed height;
wherein the second container is nestable within the third container, and within the third container upper volume, when the second container is in the collapsed position and the third container is in the collapsed position.

3. The collapsible container set of claim 2, wherein:
the first container is a funnel, wherein the first container base is configured as a first container exit tube;
the second container is a funnel, wherein the second container base is configured as a second container exit tube; and
the third container is a funnel, wherein the third container base is configured as a third container exit tube.

4. The collapsible container set of claim 3, wherein when the first container is nested within the second container, the first container exit tube is received within the second container exit tube; and further wherein when the second container is nested within the third container, the second container exit tube is received within the third container exit tube.

5. The collapsible container set of claim 3, wherein the second container height is between seventy percent and one hundred percent as great as the first container collapsed height.

6. The collapsible container set of claim 5, wherein the third container height is between seventy percent and one hundred percent as great as the second container collapsed height.

7. The collapsible container set of claim 3, wherein when the first container is in the collapsed position and nested within the second container, while the second container is also in the collapsed position and nested within the third container when the third container is in the collapsed position, the plurality of second container living hinges are positioned vertically below the third container rim.

8. The collapsible container set of claim 7, wherein when the first container is in the collapsed position and nested within the second container, while the second container is in the collapsed position and nested within the third container when the third container is in the collapsed position, the plurality of first container living hinges are positioned vertically below the third container rim.

9. The collapsible container set of claim 7, wherein the plurality of first container living hinges comprises four living hinges.

10. The collapsible container set of claim 7, wherein the first container further comprises a first container handle and the second container comprises a second container cavity formed in the rim, the first container handle being received within the second container cavity.

11. A collapsible container set, comprising:
a first container having a first container base and a first container rim, with a first container sidewall extending from the first container base to the first container rim to define a first container interior space, the first container sidewall having a plurality of first container living hinges configured to allow the first container to be positioned in either an expanded position or a collapsed position, the first container having a first container collapsed height when in the collapsed position;
a second container having a second container base and a second container rim, with a second container sidewall extending from the second container base to the second container rim to define a second container interior space, the second container sidewall having a plurality of second container living hinges configured to allow the second container to be positioned in either an expanded position or a collapsed position, the second container having a second container collapsed height when in the collapsed position, the second container when in the collapsed position having at least one second container upper folded living hinge and at least one second container lower folded living hinge from among the plurality of second container living hinges;
a third container having a third container base and a third container rim, with a third container sidewall extending from the third container base to the third container rim to define a third container interior space, the third container sidewall having a plurality of third container living hinges configured to allow the third container to be positioned in either an expanded position or a collapsed position, the third container having a third container collapsed height when in the collapsed position, the third container when in the collapsed position having at least one third container upper folded living hinge and at least one third container lower folded living hinge from among the plurality of third container living hinges;
wherein, when the first container is in the collapsed position, the second container is in the collapsed position, and the third container is in the collapsed position, the first container is nestable within the second container and the second container is nestable within the third container, such that the plurality of second container living hinges are positioned vertically below the third container rim.

12. The collapsible container set of claim 11, wherein when the first container is in the collapsed position and nested within the second container, while the second container is in the collapsed position and nested within the third container when the third container is in the collapsed position, the plurality of second container living hinges are positioned vertically below the third container rim.

13. The collapsible container set of claim 11, wherein:
the first container is a funnel, wherein the first container base is configured as a first container exit tube;
the second container is a funnel, wherein the second container base is configured as a second container exit tube; and
the third container is a funnel, wherein the second container base is configured as a second container exit tube.

14. The collapsible container set of claim 13, wherein when the first container is nested within the second container, the first container exit tube is received within the second container exit tube; and further wherein when the second container is nested within the third container, the second container exit tube is received within the third container exit tube.

15. The collapsible container set of claim 13, wherein the plurality of first container living hinges comprises four living hinges.

16. The collapsible container set of claim 13, wherein the first container further comprises a first container handle and the second container comprises a second container cavity formed in the rim, the first container handle being received within the second container cavity.

17. A collapsible container set, comprising:
a first container having a first container base and a first container rim, with a first container sidewall extending vertically upwardly and outwardly from the first container base to the first container rim to define a first container interior space, the first container sidewall having a plurality of first container living hinges configured to allow the first container to be positioned in either an expanded position or a collapsed position, the first container having a first container collapsed height when in the collapsed position, the first container further having a first container handle extending radially outward from the first container rim;
a second container having a second container base and a second container rim, with a second container sidewall extending vertically upwardly and outwardly from the second container base to the second container rim to define a second container interior space, the second container sidewall having a plurality of second container living hinges configured to allow the second container to be positioned in either an expanded position or a collapsed position, the second container having a second container collapsed height when in the collapsed position, the second container when in the collapsed position having at least one second container upper folded living hinge and at least one second container lower folded living hinge from among the plurality of second container living hinges, the second container further having a second container handle extending radially outward from the second container rim;
a third container having a third container base and a third container rim, with a third container sidewall extending vertically upwardly and outwardly from the third container base to the third container rim to define a third container interior space, the third container sidewall having a plurality of third container living hinges configured to allow the third container to be positioned in either an expanded position or a collapsed position, the third container having a third container collapsed height when in the collapsed position, the third container when in the collapsed position having at least one third container upper folded living hinge and at least one third container lower folded living hinge from among the plurality of third container living hinges;
wherein, when the first container is in the collapsed position, the second container is in the collapsed position, and the third container is in the collapsed position, the first container is nestable within the second container and the second container is nestable within the third container; and
further wherein when the first container is in the collapsed position and nested within the second container when the second container is in the collapsed position while the second container is also nested within the third container when the third container is in the collapsed position, the first container handle is in contact with the second container rim at a first contact interface and the second container handle is in contact with the third container rim at a second contact interface.

18. The collapsible container set of claim 17, wherein the first contact interface and the second contact interface lie in a common horizontal plane.

19. The collapsible container set of claim 18, wherein when the first container is in the collapsed position and nested within the second container, while the second container is in the collapsed position and nested within the third container when the third container is in the collapsed position, the plurality of second container living hinges are positioned vertically below the third container rim.

20. The collapsible container set of claim 18, wherein:
the first container is a funnel, wherein the first container base is configured as a first container exit tube;
the second container is a funnel, wherein the second container base is configured as a second container exit tube; and
the third container is a funnel, wherein the second container base is configured as a second container exit tube.
